(19) United States
(12) Patent Application Publication
(10) Pub. No.: US 2013/0112167 A1
(43) Pub. Date: May 9, 2013

(54) Connecting Rod For An Engine

(71) Applicant: Nicholas L. Norris, Findlay, OH (US)

(72) Inventor: Nicholas L. Norris, Findlay, OH (US)

(21) Appl. No.: 13/457,883

(22) Filed: Apr. 27, 2012

Related U.S. Application Data
(60) Provisional application No. 61/518,298, filed on May 3, 2011.

(51) Int. Cl. F02B 75/32

(52) U.S. Cl. CPC F02B 75/32
USPC 123/197.3

(57) ABSTRACT

A connecting rod is described for operatively joining a piston to a crankshaft in an engine. The connecting rod has elongated body having a longitudinal axis. A cap is secured to the connecting rod and defines a bore. A journal on the crankshaft is positioned in the bore to connect the second end of the connecting rod to the crankshaft. Threaded bolts secure the cap to the connecting rod. The centerline of the bolts is angularly displaced from about 2° to about 15° from the longitudinal axis of the connecting rod. The angular displacement of the centerline of the bolts provides additional clearance between the camshaft and the connecting rod.

### CROSS REFERENCE TO RELATED APPLICATIONS

This application claims the benefit of U.S. provisional patent application Ser. No. 61/518,298 filed May 3, 2011 .

### BACKGROUND OF THE INVENTION

The present invention relates to connecting rods utilized in internal combustion engines. More particularly the present invention relates to an angularly displaced connecting rod which provides additional clearance between the connecting rod and the camshaft for the internal combustion engine.

The connecting rod of the current invention is particularly well suited for use in internal combustion engines having a V configuration. In such engines a plurality of cylinders are located on each side of the V. Moveable pistons are positioned in each cylinder and the pistons are connected to a crankshaft by means of a connecting rod. The connecting rod translates the linear motion of the pistons into the rotary motion of the crankshaft. A camshaft is positioned in the center of the V shaped engine adjacent to the crankshaft. The camshaft is used to displace a push rod which actuates the intake and exhaust valves associated with each cylinder of the engine.

Such a V shaped internal combustion engine is frequently modified to increase power output of the engine. When the engine has been so modified it is frequently necessary for the connecting rods to have additional strength to handle the increased power output of the engine. One of the ways utilized to increase the power output of the engine is to increase the stroke of the engine which is an increase in the distance that the pistons move in the cylinders of the engine. The stroke is generally increased by displacing the journals on the crankshaft farther from the centerline of the crankshaft. Increasing the stroke of the engine changes the angular relationship between the camshaft and the side of the connecting rod that is adjacent to the camshaft. If the stroke is increased sufficiently there can be clearance problems between the camshaft and the side of the connecting rod. To provide adequate clearance in an engine having an increase stroke it is frequently necessary to reduce the size of the camshaft or to reduce the thickness of the connecting rod in the area adjacent to the camshaft. As the engine has been modified to increase the power output of the engine reducing the size of the camshaft or the connecting rod reduces the strength of these components at a time when it is important that these components be as strong as possible.

### SUMMARY OF THE INVENTION

The invention is directed to a connecting rod for operatively joining a piston to a crankshaft in an engine. A camshaft is positioned adjacent the crankshaft in the engine. The connecting rod has elongated body having a first end and a second end. The elongated body having a longitudinal axis that extends from the first end to the second end. A first bore is positioned in the first end and a pin is positioned in the first bore to connect the first end to the piston. A cap is secured to the second end of the connecting rod. The cap in the second end defines a second bore. An aperture is positioned on each side of the cap. A threaded passageway is positioned on each side of the second end where the threaded passageways are in alignment with the apertures in the cap. A journal on the crankshaft is positioned in the second bore to connect the second end of the connecting rod to the crankshaft. A threaded bolt is positioned in each of the apertures. The threaded bolts threadingly engage the threaded passageways to secure the cap to the second end of the connecting rod. The centerline of the bolts is angularly displaced from about 2° to about 15° from the longitudinal axis of the connecting rod. The angular displacement of the centerline of the bolts provides additional clearance between the camshaft and the connecting rod.

It is an object of the present invention to provide a connecting rod that can be used in an engine having an increase stroke that is strong enough to accommodate the increased power output of the engine. It is an additional objective of the invention to provide a connecting rod for an engine having an increased stroke that provides additional clearance between the connecting rod and the camshaft of the engine.

Other objects and advantages of the present invention will become apparent to those skilled in the art upon a review of the following detailed description of the preferred embodiments and the accompanying drawings.

### BRIEF DESCRIPTION OF THE DRAWINGS

FIG. 1 is a cross sectional view of an engine with a prior art connecting rod.

FIG. 2 is a front elevation view, a side elevation view and a cross sectional view of a prior art connecting rod.

FIG. 3 is a cross sectional view of an engine with the connecting rod of the present invention.

FIG. 4 is a front elevation view, a side elevation view and a cross sectional view of the invention of the present invention.

### DETAILED DESCRIPTION OF THE PREFERRED EMBODIMENT(S)

The invention is directed to a connecting rod for use in an internal combustion engine. The connecting rod operatively joins the piston to the crankshaft of the engine. The connecting rod transfers the linear motion of the piston into the rotary motion of the crankshaft. The internal combustion engines for which the connecting rod has been designed have a camshaft that is positioned adjacent the crankshaft. The design of the connecting rod provides additional clearance space between the connecting rod and the camshaft. The features of the invention will be more readily understood by reference to the attached drawings in connection with the following description.

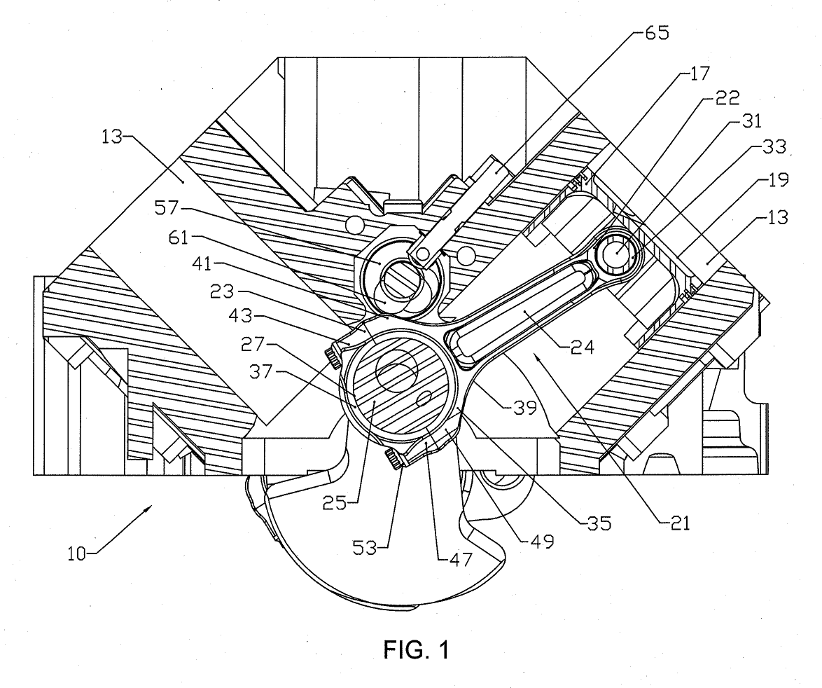

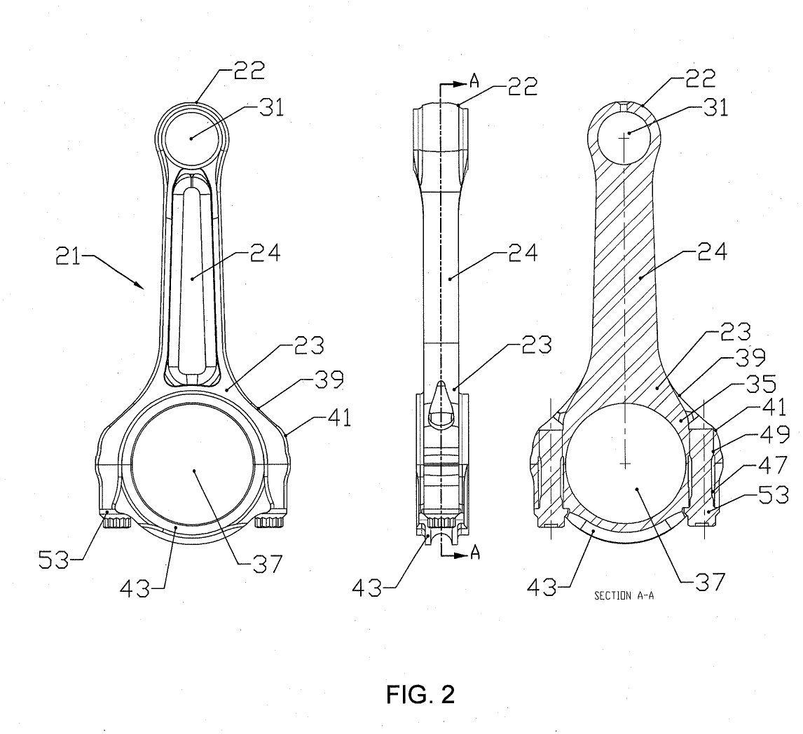

FIGS. 1 and 2 show a prior art internal combustion engine 10 having two banks of cylinders arranged in a V configuration. A piston 17 is positioned in each of the cylinders. The piston is caused to move upwardly and downwardly in the cylinder 13 due to the ignition of a fuel air mixture that acts against the upper surface 19 of the piston in a manner that is well known in the art. A connecting rod 21 extends between the piston 17 and the crankshaft 25. The connecting rod has a first end 22 that is operatively connected to the piston 17, a second end 23 that is operatively connected to a journal 27 on the crank shaft 25 and a beam section 24 that extends between the first and second ends. A bore 31 is positioned in the first end 22 of the connecting rod 21 and a pin 33 is positioned in the bore 31 to secure the piston 17 to the first end 22 of the connecting rod.

The second end of the connecting rod 21 has an enlarged section 35 that defines a second bore 37. Radiused portions 39 on each side of the connecting rod 21 transition from the smaller section of the beam section of the connecting rod with the enlarged section 35 on the second end 23 of the connecting rod. A shoulder region 41 is formed on each side where the radiused sections join the enlarged section. A cap 43 is removably secured to the second end 23 of the connecting rod to form a portion of the second bore 37. The removable cap allows the enlarged section 35 of the connecting rod 21 to be positioned around the journal 27 on the crankshaft 25. Once the enlarged section 35 is positioned around the journal 27 the cap 43 is put in place to form the remainder of the second bore 37 and to secure the second end 23 of the connecting rod 21 to the crankshaft 25. An aperture 47 is located on each side of the cap 43 and a threaded passageway 49 is located on each side of the enlarged section 35 of the second end 23 of the connecting rod. The threaded passageway 49 is positioned to be in alignment with the apertures in the cap 43. A threaded bolt 53 is positioned in each of the apertures so that the threaded bolts threadingly engage the threaded passageways 49 in the enlarged section 35. The threaded bolts act to secure the cap to the second end 23 of the connecting rod 21.

A camshaft 57 is positioned between the cylinders 13 of the engine 10 adjacent the crankshaft 25. The camshaft has cam lobes 61 that are used to displace pushrods 65 that are used to operate the intake and the exhaust valves associated with the cylinders 13. The intake and the exhaust valves are well known in the art and have not been shown in detail. As shown in FIG. 1 there can frequently be interference issues between the shoulder region 41 of the radiused portion 39 on the enlarged section 35 on the second end 23 of the connecting rod 21 with the cam lobe 61 on the camshaft 57. The clearance issue becomes more significant when the stroke of the engine 10 is increased to increase the capacity or volume of the cylinder 13 and the power output of the engine. The stroke which is the distance the piston 17 travels in the cylinder 13 is increased by displacing the center line of the journal 27 farther from the center line of the crankshaft 25. Displacing the journal in this manner allows the piston 17 to travel farther in the cylinder 13 in a direction towards the crankshaft 25 thereby increasing the stroke of the engine 10. Displacing the center line of the journal 27 farther from the center line of the crankshaft 25 results in the shoulder region 41 on the radius portion 39 of the second end 23 of the connecting rod 21 to move in a direction towards the camshaft 57. When the stroke of the engine 10 has been sufficiently increased, which is desirable to increase to output of the engine, there can be clearance issues between the shoulder region 41 and the lobe 61 on the camshaft 57. When there are clearance issues, size of the shoulder region 41 of the connecting rod 21 can be made smaller. The size in this area of the connecting rod is essential for providing the strength to allow the connecting rod to handle the increased power output of the engine due to the increase stroke. As the connecting rod changes the linear reciprocating movement of the piston 17 into the rotary movement of the crankshaft 25 it is important that the connecting rods be sufficiently strong to prevent failure of the engine. The stroke in most engines is increased to provide a high performance engine and a failure of the connecting rod is catastrophic and very expensive to repair. To accommodate the clearance issue between the shoulder region 41 and the cam lobes 61 engine designers have usually been forced to reduce the diameter of the camshaft 57 or the cam lobes 61 to provide clearance with the shoulder region 41. Reducing the size of the camshaft 57, however, creates its own deficiencies on the reliability and performance of the engine 10. The smaller diameter camshaft has reduced strength and it is possible to have flex in the camshaft that reduces the reliability and performance of the camshaft. The reduced size of the camshaft or the cam lobes also makes it more difficult to achieve the degree of actuation for the push rods to maximize the performance for the intake and exhaust valves associated with the cylinders 13 of the engine 10. Accordingly, the solution that has been utilized in the prior art to accommodate the increase in stroke in an engine has created difficulties in other parts of the operation of the engine. Accordingly, there is a need in the industry for an increased stroke high performance V type engine where there is increased clearance between the shoulder region 41 of the connecting rod 21 and the cam lobe 61 on the camshaft 57.

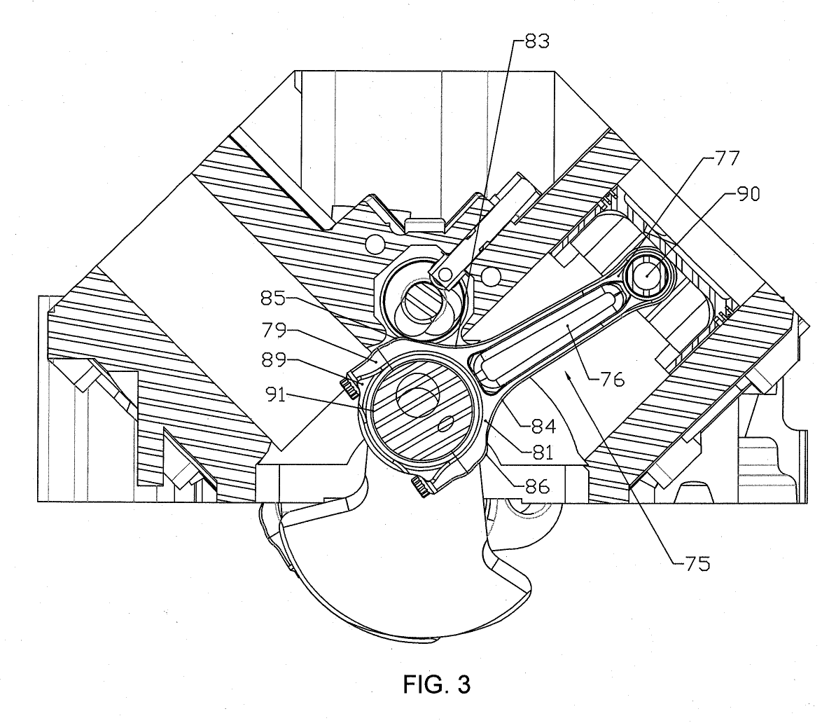

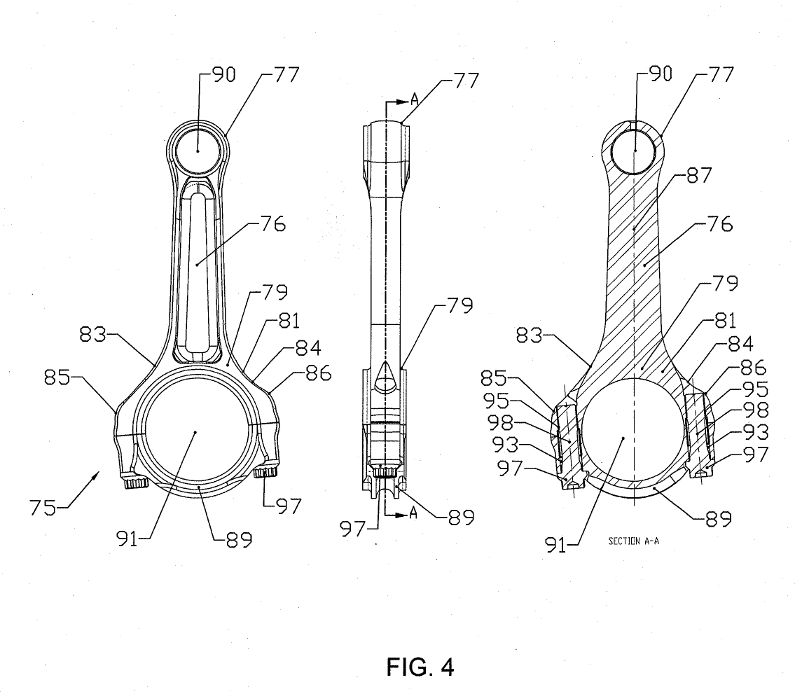

FIGS. 3 and 4 show the connecting rod 75 of the present invention that overcomes the deficiencies of the prior art connecting rods when increasing the stroke of an internal combustion engine. The features of the connecting rod 75 are similar to the features described with respect to the prior art connecting rod shown in FIGS. 1 and 2. All of the features of the connecting rod of the present invention will not be described in detail, but only the features that are different from the prior art connecting rods. As shown in FIGS. 3 and 4 the connecting rod 75 of the present invention has a second end 79 that has an enlarged section 81. A first radiused portion 83 and a second radiused portion 84 form a transition zone between the smaller section of the first end 77 and the beam section 76 of the connecting rod and the enlarged section 81 on the second end 79 of the connecting rod. A first shoulder 85 and a second shoulder 86 are formed on opposite sides of the connecting rod 75 where the first radiused portion and second radiused portion transition into the second end 79. The first shoulder is positioned adjacent the first radiused portion and the second shoulder positioned adjacent the second radiused portion. A cap 89 is connected to the second end 79 of the connecting rod 75 to close the second bore 91 that is formed in the second end 79 of the connecting rod 75. The second bore is positioned around the journal 27 on the crankshaft 25 in the manner previously described. An aperture 93 is positioned on each side of the cap 89 and a threaded passageway 95 is positioned in the enlarged section 81 of the second end 79. The aperture 93 on each side of the cap 89 is disposed to be in alignment with the threaded passageways 95 located on each side of the enlarged section 81 at the second end of the connecting rod 75. A threaded bolt 97 is positioned in the apertures 93 and threadingly engages the threaded passageways 95 to secure the cap 89 to the second end 79 of the connecting rod 75 in the same manner as previously described. A longitudinal center line 87 extends from the first bore 90 on the first end 77 through the second bore 91 on the second end 79 of the connecting rod 75. The apertures 93 in the cap 89 and the threaded passageways 95 in the enlarged section 81 on the second end 79 have longitudinal centerlines 98. The longitudinal centerlines 98 on each side of the connecting rod 75 are positioned in parallel orientation. The centerlines 98 are, however, rotated with respect to the longitudinal centerline 87 of the connecting rod 75. The centerlines 98 are rotated from about 2° to about 15° in a direction towards the camshaft 57 or in a direction towards the centerline of the V shaped engine 10. The rotation of the centerlines 98 in this direction allows a larger radius to be used for the first radiused portion 83 which is on the side of the connecting rod 75 that faces camshaft and the center of the engine. The first radiused portion 83 has a larger radius than the second radius portion 84 which is on the other side of the connecting rod 75. The longer radius for the first radius portion 83 also results in the first should 85 being located farther from the first bore 90 on the first end 77 of the connecting rod 75. The second shoulder 86 on the opposite side of the connecting rod is located closer to the first bore 90 then the first shoulder 85. The rotation of the centerlines 98 towards the center of the engine and the increased radius for the first radius portion 83 provides additional clearance between the first radius portion and first shoulder 85 with the camshaft 57 and cam lobes 61. The increased clearance allows the camshaft 57 to be as large as possible which enhances the strength of the camshaft and does not result in any diminishment of the operation of the cam, cam lobes, the push rods or the valve train that are utilized for the engine. It has been found in practice that the modification of the present invention for the connecting rod 75 can result in an increase in clearance between connecting rod and the camshaft lobes from about 0.025 of an inch to about 0.080 of an inch. Also in practice it has been found preferable to have the centerlines 98 rotated from about 3° to about 7° as this provides adequate additional clearance for most engine applications. The increased radius in the first radiused portion 83 also distributes stress loads over a larger area and therefore, increases the fatigue strength of the connecting rod 75.

The above detailed description of the present invention is given for explanatory purposes. It will be apparent to those skilled in the art that numerous changes and modifications can be made without departing from the scope of the invention. Accordingly, the whole of the foregoing description is to be construed in an illustrative and not a limitative sense, the scope of the invention being defined solely by the appended claims.

We claim:

1. A connecting rod for operatively joining a piston to a crankshaft in an engine having a camshaft positioned adjacent the crankshaft, the connecting rod comprising:
an elongated body having a first end and a second end; the elongated body having a longitudinal axis extending from the first end to the second end;
a first bore positioned in the first end;
a pin positioned in the first bore to connect the first end to the piston;
a cap secured to the second end, the cap and the second end defining a second bore;
an aperture positioned on each side of the cap;
a threaded passageway positioned on each side of the second end, the threaded passageway being in alignment with the apertures respectively;
a journal on the crankshaft being positioned in the second bore to connect the second end to the crankshaft;
a threaded bolt positioned in each of the apertures, the bolts threadingly engaging the threaded passageways to secure the cap to the second end and to define the second bore, the centerline of the bolts being angularly displaced from about 2° to about 15° from the longitudinal axis to provide additional clearance between the camshaft and the connecting rod.

2. The connecting rod of claim 1 wherein the centerline of the bolts is displaced in a direction towards the camshaft.

3. The connecting rod of claim 2 wherein the second end has an enlarged section to accommodate the large diameter of the crank pin and the second bore.

4. The connecting rod of claim 3 wherein a curved section is positioned on each side of the connecting rod to transition from the elongated body to the enlarged section of the second end, the curved section on each side of the connecting rod defining a radius of curvature.

5. The connecting road of claim 2 wherein the displacement of the centerline of the bolts towards the camshaft allows the use of a larger radius of curvature on the side of the connecting rod that is adjacent the camshaft.

6. The connecting rod of claim 2 wherein the centerline of the bolts is displaced from about 3° to about 7°.
